(19) United States
(12) Patent Application Publication
(10) Pub. No.: US 2022/0067311 A1
(43) Pub. Date: Mar. 3, 2022

(54) Methods and System for Magnetic Image Identification

(71) Applicant: Lexmark International, Inc., Lexington, KY (US)

(72) Inventors: Ahmed Hamad Mohamed Eid, Lexington, KY (US); Tomasz Jan Cholewo, Lexington, KY (US)

(21) Appl. No.: 17/464,055

(22) Filed: Sep. 1, 2021

Related U.S. Application Data
(60) Provisional application No. 63/073,588, filed on Sep. 2, 2020.

(51) Int. Cl. G06K 7/08

(52) U.S. Cl. CPC G06K 7/087

(57) ABSTRACT

Described is an invention that provides methods to identify key features from magnetic image captures of complex magnetic fields of randomly positioned and oriented magnetized particles in an object. The key features are described in a compact form to generate a unique identifier that services as a “fingerprint” of a chip.

### CROSS REFERENCES TO RELATED APPLICATIONS

This application claims priority and benefit under 35 U.S.C. 119(e) from U.S. provisional application No. 63/073,588 titled “Methods and System for Magnetic Image Identification,” having a filing date of Sep. 2, 2020.

### BACKGROUND

### 1. Field of the Invention

This invention relates generally to image identification and more particularly to matching content in images.

### 2. Description of the Related Art

There is no existing solution that analyzes images of complex magnetic fields, extracts key features from the images, and generates a unique identifier of the magnetic field for comparison to identifiers stored in an enrollment database.

### SUMMARY OF THE INVENTION

This invention provides methods to identify key features from magnetic image captures of complex magnetic fields of randomly positioned and oriented magnetized particles in a chip (object). The key features are then described in a compact form to generate a unique identifier that serves as a “fingerprint” of a chip. The system includes several building blocks to pre-process captured images, extract and describe key features, and store the “fingerprints” of different chips, for later matching of chips in the field as a part of the authentication process.

Randomly positioned and oriented magnetized particles in a chip can produce a complex magnetic field pattern on the surface of the chip. It is then desired to image that magnetic field for further analysis to create a unique identifier of that chip for authentication purposes.

### BRIEF DESCRIPTION OF THE DRAWINGS

Having thus described the invention in general terms, reference will now be made to the accompanying drawings, which are not necessarily drawn to scale, and wherein:

FIG. 1 shows an image of magnetic flux component Bx.

FIG. 2 shows an image of magnetic flux component By.

FIG. 3 shows an image of magnetic flux component Bz.

FIG. 4 shows an image of the derived quantity of magnitude of magnetic flux components Bx and By.

FIG. 5 shows an image of the derived quantity of the resolved angle of magnetic flux components Bx and By.

FIG. 6 shows a magnetic image of a chip with low frequency distortion and high frequency noise.

FIG. 7 shows the image from FIG. 6 after wavelet filter is applied to provide a cleaner image with noise and distortion removed.

FIG. 8 shows an input image for detecting features of the magnetic flux in a single field component.

FIG. 9 shows an example of key features of FIG. 8 marked with circled plus signs.

FIG. 10 shows an example of key feature descriptors where the single descriptor represents only one specific feature.

FIG. 11 shows another example of key feature descriptors where the single descriptor represents only one specific feature.

FIG. 12 shows a flowchart of the method steps enrolling and authenticating a magnetic image based on identifiers.

FIG. 13 shows a visual presentation of the enrollment steps.

FIG. 14 shows a visual presentation of the authentication steps.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology, terminology and dimensions used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art. The dimensions of the magnetic particles, separations between particles and sensor locations are interrelated and can be proportionally scaled with respect to each other to provide different sized solutions.

The present invention is described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views. The scaling or signature lengths of numerical range to 255 (8 bit binary) or 512 length are considered arbitrary for reference. These can be scaled to any value to represent the resolution of the smallest number or maximum scale.

This invention provides methods to identify key features from magnetic image captures of complex magnetic fields of randomly positioned and oriented magnetized particles in a chip (object). The key features are then described in a compact form to generate a unique identifier that serves as a “fingerprint” of a chip. The system includes several building blocks to pre-process captured images, extract and describe key features, and store the “fingerprints” of different chips, for later matching of chips in the field as a part of the authentication process.

Methods

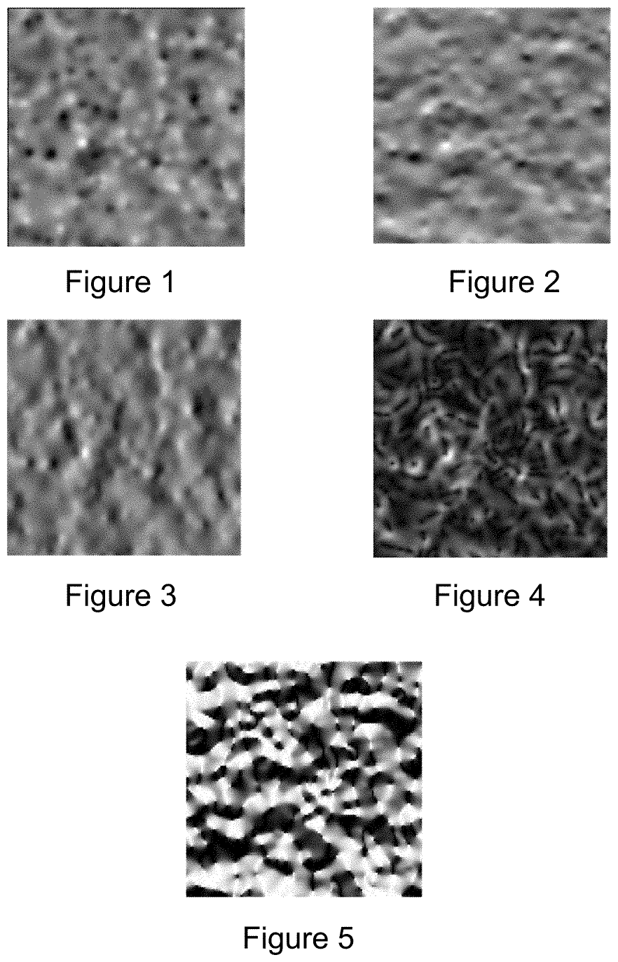

Images are acquired using a magnetic sensor such as Hall-effect sensor or an array of such sensors. The generated data represent the magnetic flux components in different directions for example Bx, By, and Bz in the Cartesian coordinate system as shown in FIGS. 1, 2, and 3 respectively. The images in FIGS. 1, 2, and 3 are for the magnetic fields in the z, x, and y directions, respectively, measured by sensor(s). The data coming from the sensor(s) are real values measured in Tesla or Gauss. The most positive values represent strong positive magnetic field along the coordinate direction, while the most negative values represent strong magnetic field oriented opposite to the coordinate direction. Zero or small values represent no or weak magnetic field. In representing these values in images, the values are scaled to be in range 0 to 255 (8-bit images), where: 255 (bright) represents the most positive magnetic field, and 0 (dark) represents the most negative magnetic field. Mid-range values near 127 (gray) represent zero or weak magnetic field.

Additional components can be derived from the main components such as the magnitude (Bₓ, B_{y}), where magnitude=\sqrt{Bₓ²+B_{y}²}, and angle (Bₓ, B_{y}), where φ=tan⁻¹(By/Bx), as shown in FIGS. 4 and 5, respectively, or a function of the angle such as cos(φ) or sin(φ). With the magnitude and angle, Bx and By may be represented in polar coordinates to yield additional features, so we represent the Bx and By in polar coordinates as magnitude and phase/angle. Here again, the values are scaled to be in valid range for the 8-bit images. For the magnitude in FIG. 4, the value is always non-negative, so 255 represents strong magnetic field and 0 represents the zero magnetic field. For the phase or function of the phase shown in FIG. 5, represented are the peaks and valleys of the function (not necessarily representing a direct relation to the magnetic field strength, but which can provide additional features to use).

For the images local image features (keypoints) are sought that can be used as a signature of the chip as discussed below. For example, high contrast contents that represent corners, corner-like, or points on contours (i.e., two-dimensional, not just one-dimensional edges) features are good candidates for such features. Local-image-descriptor algorithms are used to detect and represent the features and generate somewhat unique descriptors (for example, 512 bits each) for the keypoints. The descriptor is rotation, shift, and scale invariant, so that the descriptor is not affected by such transformations that are expected during the capture of the magnetic image (that is fiducials are not needed to tell the orientation of the capture relative to the enrolled image of the chip).

The following sections provide descriptions of the methods and blocks of the object identification system.

### Data Preprocessing

Data could be normalized to remove biases or attain a pre-defined range. For example, the mean and standard deviation of the data can be used to get a normalized data distribution. The maximum and the minimum of the data can be used as well to normalize the data range.

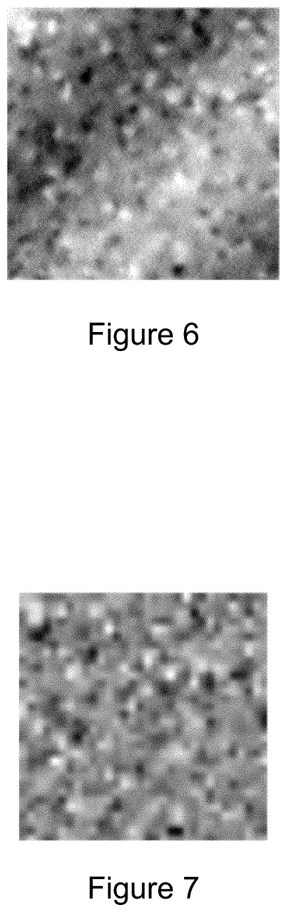

Since data can have noise and/or distortion, applying data filtering could help extract robust features and better description of the object. For example, a band-pass filter or wavelets filtering approaches can be applied to remove undesired contents from the data. FIG. 6 shows a magnetic image of a chip with low frequency distortion and high frequency noise. Applying a wavelet filter provided a cleaner output image as shown in FIG. 7.

If further denoising would be necessary, an edge preserving filter can be applied. Filters of such kind can remove high frequency unstructured contents while preserving the structured contents like the edges or the boundaries of objects in the image.

Since sensors are subjected to have some random dead elements, image de-speckle techniques such as median filtering can be used to clean the images.

### Chip Identification

Extracting distinct features with preferably random details around these key features is crucial for generating a unique identifier for each chip (object). Due to the randomness of position, orientation, and the size of the magnetized particles in the chip and the interaction among them, a unique distribution of the magnetic flux results in each chip. Adding more main field components and/or derived components can increase the level of uniqueness.

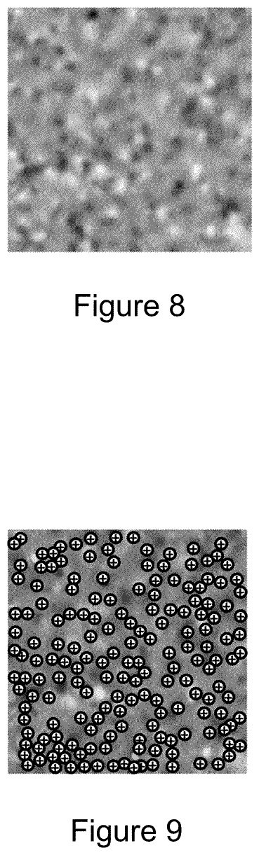

After applying preferable data preprocessing techniques, key features such as corners, edges, and/or blobs are detected using known techniques. Examples of such techniques include Harris, minimum eigenvalue, or FAST for corner detection. Among such techniques, FAST is preferred due to its better speed of execution. FIG. 8 shows an example of a captured magnetic image with the detected key features are marked by circled plus signs in FIG. 9. The extracted key features are preferably selected to be rotation-, shift-, and scale-invariant to allow spatially unconstrained captures without adding artificial marks (fiducials) to the chip (object).

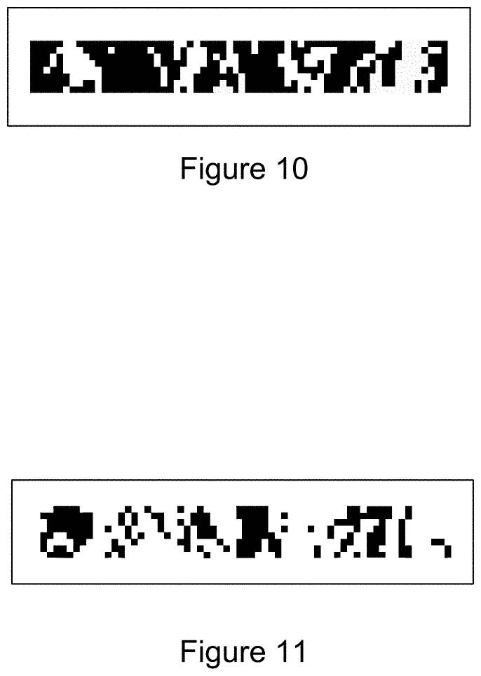

While extracting locations of key features provides a first level of uniqueness for each chip, the complexity of the details of a key feature neighborhood and the description of the mutual relation of the key feature and its neighborhood add more levels of uniqueness to each chip. Known local image descriptors techniques are preferably used to encode the interaction of a single key feature and its surroundings. Examples of such techniques include BRISK, AKAZE, SIFT and SURF, with BRISK and AKAZE are preferred due to their binary representation of descriptors that expedite the matching process. Examples of key feature descriptors are shown in FIGS. 10 and 11, where the single descriptor represents only one specific feature. While the descriptors shown in FIGS. 10 and 11 are represented as a two-dimensional array of bits (for example, 1 for black and 0 for white), it can be represented as a sequence of bits in a single row.

Since a single image of a chip could provide hundreds of key features and their corresponding descriptors, the data type and size of the descriptors are preferably selected in such a way to optimize the data storage capacity and enhance the performance of the data matching techniques. For example, a descriptor of binary format with size less than or equal 512 bits is preferred compared to ones based on floating point or integer data types.

### Storing IDs and Auxiliary Data

Since the descriptors for each chip constitute the unique identifier either individually or collectively based on the desired level of uniqueness, a number of these descriptors are stored in, for example, a database referring to the corresponding chip. This kind of storage or database should be accessible either remotely or locally to facilitate the authentication of the chips.

While descriptors of each chip serve as its “fingerprint,” auxiliary data of the chip can help verify the identity of the chip and increase the confidence of authenticating chips. Examples of the auxiliary data could include: the magnetic image(s), and/or the location of each key feature in the corresponding image. The magnetic image and the location of the key features can be used as an optional verification step where the images can be aligned, given the locations of the matched key features, and then an image correlation or similarity approach can be used to find a score of how similar the matched images are. A high similarity/correlation score of 0.85 or above can provide such verification.

### Data Matching

To authenticate a chip, magnetic images are captured, and a pipeline of pre-processing and identification approaches as described above is applied to the captured images to extract unique identifiers. Then, these identifiers are compared for a match against the database of different chips identifiers.

Different approaches can be used to determine whether the chip in the field would be accepted or rejected. For example, all the descriptors calculated from the magnetic images of an unknown chip “X,” are compared to all descriptors of each chip stored in the database one chip at a time. In matching a descriptor to a stored descriptor, a distance measure can be used such as the Hamming distance. A descriptor is considered matched if the measured distance is below a certain threshold D. With N chips in the database, the unknown chip “X” can be accepted if it achieves a maximum matching score (S₁) with a particular set of descriptors (identifying a unique chip) in the database, provided that S₁>Th₁, where Th₁ is a pre-defined threshold.

Additional matching criterion can be used in a way to consider the second-best match. For example, if the best matching score is S₁, and the second-best score is S₂, then the ratio S₁/(S₁+S₂) should be large enough (for example, S₁/(S₁+S₂)>Th₂, Th₂=0.9) to accept chip “X,” provided that S₁>Th₁.

Instead of matching all descriptors of chip “X” to a particular set of descriptors (i.e., belonging to the same chip), one descriptor of a chip “X” is compared against the full set of descriptors in the database. A tallying criterion is then used to determine the set in the database that register minimum tally=Th₁. This can lead to a better performance since the process can stop matching when the set attains the minimum tally.

### Validation

A cross correlation function, or other similarity measure, can be used to provide an additional verification step if more than one set of descriptors show comparable matching score. However, calculating the similarity score of the image of an unknown chip requires storing the images of all chips at the time of enrollment in addition to the locations of the descriptors in each image. That may increase the size of the stored data.

The images of the chips, stored in the database, that registered high and comparable scores to the unknown chip can be aligned with the image of the unknown chip. This alignment can be found by calculating the geometric transformations (rotation, shift, and scale) between these (candidate) chips and the unknow chip by using the locations of the matched descriptors in the corresponding chips. Similarity scores are then calculated for the aligned images. The unknown chip is validated if the similarity score of one of the candidate chips is greater than a pre-defined threshold, Th₃, where for example, Th₃=0.85.

### Magnetic Image Identification System

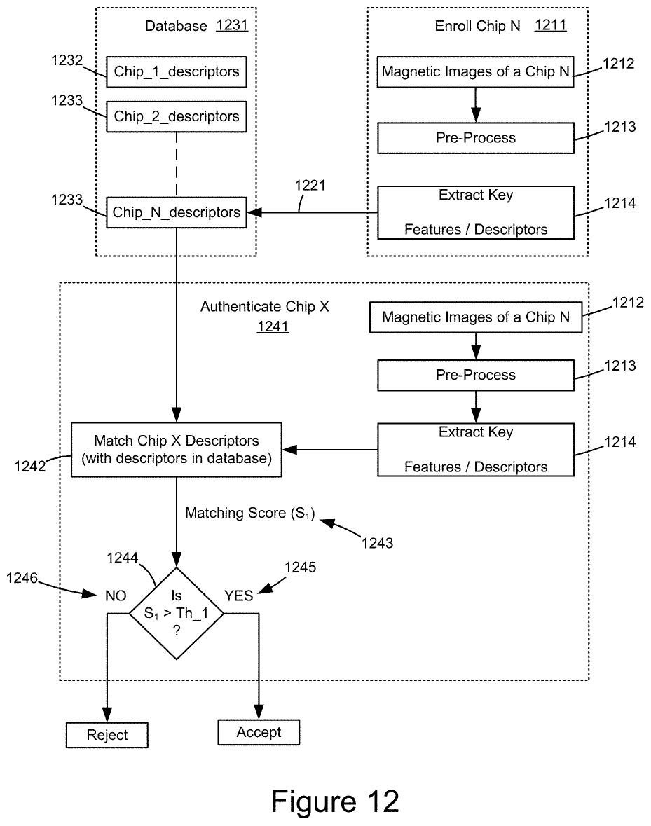

The methods described above can be pipelined as shown in FIG. 12. At the time of enrollment 1211, the magnetic images are captured 1212, pre-processed 1213, and described by sets of unique descriptors 1214 to form the identifiers (“fingerprints”). The generated “fingerprints” are then stored 1221 in a database 1231.

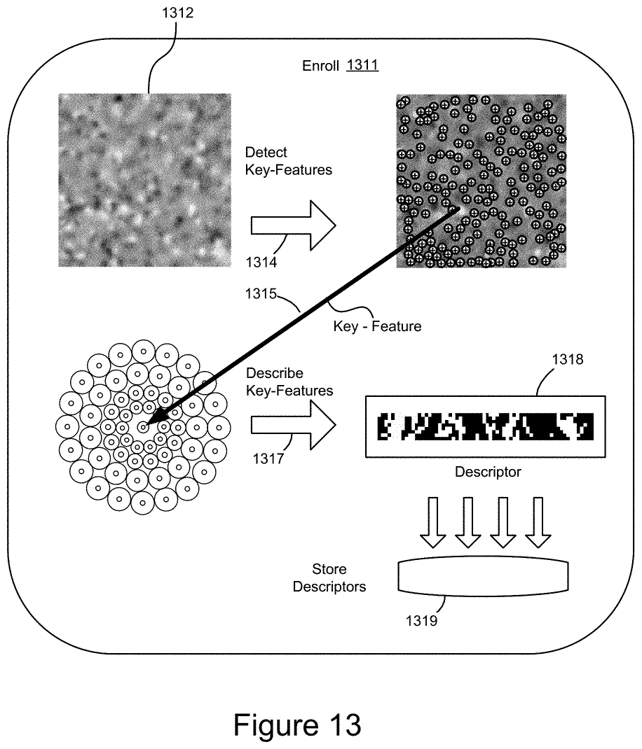

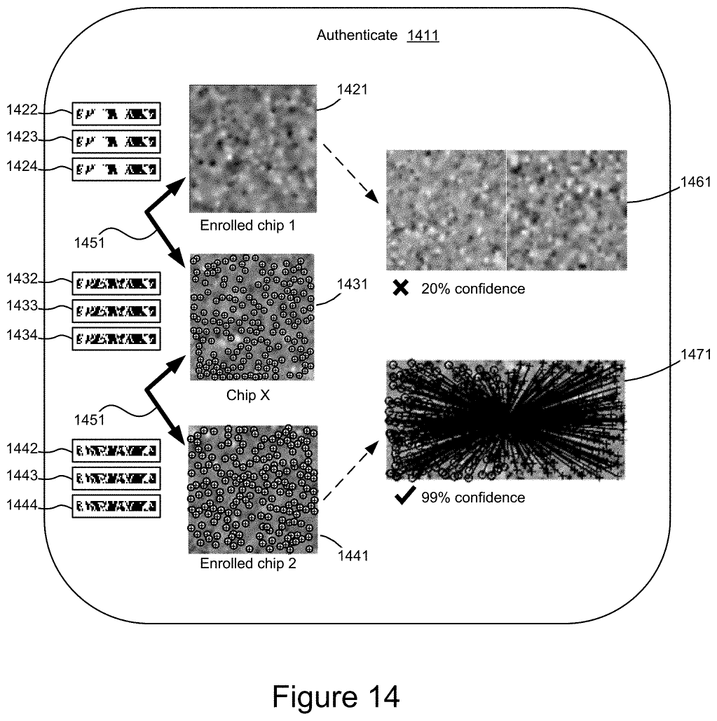

At the time of authentication 1241, the same pipelined methods 1212, 1213, 1214 are used to generate the identifier of the unknown chip. Then, this identifier is compared to the stored identifiers 1242 in the database 1231 to find a matching score 1243 that is compared in 1244 to a pre-defined threshold and decide whether the unknown chip is 1245 matching any of the enrolled ones or 1246 is not, as described above. An example of the enrollment and authentication steps is shown in FIGS. 13 and 14.

In FIG. 13, the enrollment process 1311 is shown beginning with the captured magnetic image 1312. Key features are identified 1314 and key features extracted 1315. Extracted key features are selected 1314, described 1317 by the relative contrast of the current key feature and its neighbors, encoded 1318, and stored 1319 in the database.

In the authentication 1411 process, the encoded features 1422, 1423, 1424 of the magnetic image for an enrolled chip “1” 1421 are compared 1451 with the encoded features 1432, 1433, 1434 of Chip “X” for a match. A poor confidence match 1461 is rejected. While, on the other hand, when the encoded features 1442, 1443, 1444 of the magnetic image for an enrolled chip 1441 are compared 1451 with the encoded features 1432, 1433, 1434 of Chip “X” for a match, the unknown chip “X” is identified as enrolled chip “2” 1441 in the database with 99% confidence. For example, a high confidence match 1471 can be high if the number of matches, S₁, of chip X as the best match is high while the second-best score S₂, of another chip in the database, is very low. In this case, the confidence score S₁/(S₁+S₂) should approach 1 (or 100%) indicating a high confidence in accepting chip “X,” provided that S₁>Th₁ as described above.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

We claim:

1. A method for normalizing data to remove biases or attain a pre-defined range comprising:
using a mean and standard deviation of a data to get a normalized data distribution, where a maximum and a minimum of a data is used to normalize a data range;
applying data filtering to reduce noise and/or distortion to help extract robust features and a better description of an object;
applying an edge preserving filter to further denoise the data to remove high frequency unstructured contents while preserving structured contents like edges or boundaries of objects in an image; and
using image de-speckle techniques to clean the image of random dead elements from one or more sensors.

2. The method of claim 1 where the data filtering is a band-pass filter.

3. The method of claim 1 where the data filtering is wavelets filtering.

4. The method of claim 1 where the de-speckle technique is median filtering.

5. A method of identification to extract distinct features with preferably random details around key features for generating a unique identifier for an object comprising:
identifying a distribution of a magnetic flux in an object;
adding more main field components and derived components to increase a level of distinctiveness;
applying preferable data pre-processing techniques;
detecting key features such as corners, edges, and/or blobs; and
extracting key features that are selected to be rotation-, shift-, and scale-invariant to allow spatially unconstrained captures.

6. The method of claim 5 where no artificial marks such as fiducials are added to the object.
